(19) United States
(12) Patent Application Publication
(10) Pub. No.: US 2003/0053793 A1
(43) Pub. Date: Mar. 20, 2003

(54) Analog/digital recording and playback system and related method

(76) Inventors: Peter Holzmann, San Jose, CA (US); Tong-Hsien Thomas Chiang, San Jose, CA (US); Saleel V. Awsare, Redwood City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/960,029

(22) Filed: Sep. 20, 2001

(51) Int. Cl. H04N 5/76

(52) U.S. Cl. 386/46; 386/112; 386/124

(57) ABSTRACT

An analog/digital recording and playback system that is capable of recording and playing back a digital signal to and from a memory array at a different data rate than the sampling and retrieval of an analog signal to and from the memory array. This is accomplished by converting the digital signal into a continuous-time analog signal or vice-versa at a first sampling rate. Then, recording or retrieving analog samples of the continuous-time analog signal to and from the memory array at a second sampling rate. The first and second sampling rate need not be the same. This feature makes the analog recording and playback section independent of the digital recording and playback section of the system. An advantage of the system is that it is more versatile since different digital signals with different sampling rates can be received or generated, allowing the system to interface with other systems requiring different digital formats.

### FIELD OF THE INVENTION

This invention relates to analog/digital recording and playback systems with multilevel storage arrays, and in particular, to an analog/digital recording and playback system and related method that is capable of receiving and transmitting digital signals at a clock rate different than the clock rate for sampling and generating analog signals.

### BACKGROUND OF THE INVENTION

Recording and playback systems are now designed to receive and transmit both analog and digital signals. Both analog and digital signals are typically stored in a common multilevel storage array. In the case of an input analog signal, a sampled analog value is stored in a cell of the multilevel storage array as a particular voltage level substantially equal to the sampled analog value (depending on the resolution of the programning circuit). In the case of an input digital data signal, a sampled digital signal is stored in a cell of the multilevel storage array as either of two voltage levels above or below a pre-determined threshold (logic high or logic low voltage level). In the case of an input digital audio signal, a sampled digital signal is stored in a cell of the multilevel storage array as a particular voltage level substantially equal to the sampled analog representation of the digital sample (depending on the resolution of the programming circuit).

FIG. 1 illustrates a block diagram of a prior art analog/digital recording and playback system 100. The system 100 consists of an analog program/read circuit 102, a clock 104, a multilevel storage array 106, and a digital program/read circuit 108. During recording of an analog signal, the analog program/read circuit 102 receives and samples the input analog signal at a rate determined by the clock 104. After sampling the input analog signal, the analog program/read circuit 102 programs the corresponding cell of the multilevel storage array. During playback of a stored analog signal, the analog program/read circuit 102 retrieves the analog voltage samples stored in the multilevel storage array 106 at a rate determined by the clock 104, and then filters the samples to generate a continuous-time analog signal.

Similarly, during recording of an input digital signal, the digital program/read circuit 108 clocks in the input digital signal at a rate determined by the clock 104. After clocking in the input digital signal, the digital program/read circuit 108 converts the digital samples to analog samples and programs the corresponding cells of the multilevel storage array. During playback of a stored digital signal, the digital program/read circuit 108 retrieves the analog samples stored in the multilevel storage array 106 and outputs the digital samples stored at a rate determined by the clock 104 or the analog program/read circuit 102 retrieves and outputs the analog samples stored in the multilevel storage array 106 at a rate determined by the clock 104.

A shortcoming of the prior art analog/digital recording and playback system 100 arises from the fact that the clock 104 is common to both the analog/program read circuit 102 and to the digital program/read circuit 108. Thus, the digital signal must be clocked in and out of the system 100 at the same rate as the sampling and retrieval of the analog signal. This prevents the prior art analog/digital recording and playback system 100 from receiving and generating digital signals which require a sample rate that is different from the internal sample rate.

Thus, there is a need for an improved analog/digital recording and playback system that can receive and transmit digital signals at a different clock rate than that of its internal clock. Such a need and others are met with the analog/digital recording and playback system in accordance with the invention.

### SUMMARY OF THE INVENTION

An aspect of the invention relates to an analog/digital recording and playback system that is capable of recording and playing back of a digital signal to and from a memory array at a different sample rate than the sampling and retrieval rate of the equivalent analog signal to and from the memory array. This is accomplished by converting a digital signal into a continuous-time analog signal or vice-versa at a first sample rate. Then, recording or retrieving analog samples of the continuous-time analog signal to and from the memory array at a second sampling rate. The first and second sampling rates need not be the same. This feature makes the analog recording and playback section independent of the digital recording and playback section of the system. An advantage of the system is that it is more versatile since different digital signals with different data rates can be received or generated, allowing the system to interface with other systems requiring different digital formats.

Other aspects, features and techniques of the invention will become apparent to one skilled in the relevant art in view of the following detailed description of the invention.

### BRIEF DESCRIPTION OF THE DRAWINGS

FIG. 1 illustrates a block diagram of a prior art analog/digital recording and playback system;

FIG. 2 illustrates a block diagram of an exemplary analog/digital recording and playback system in accordance with the invention;

FIG. 3 illustrates a block diagram of a more detailed embodiment of an analog/digital recording and playback system in accordance with the invention; and

FIG. 4 illustrates a block diagram of an exemplary codec in accordance with the invention.

### DETAILED DESCRIPTION OF THE INVENTION

FIG. 2 illustrates a block diagram of an exemplary analog/digital recording and playback system 200 in accordance with the invention. The system 200 comprises an analog program/read circuit 202, a clock 204 for the analog program/read circuit 202, a multilevel storage array 206, a digital-to-continuous time analog interface circuit 208, and a clock 210 for the digital-to-continuous time analog interface circuit 208. In the case of recording of an input analog signal, the analog program/read circuit 202 receives and samples the input analog signal at a sample rate determined by the clock 204. After sampling the input analog signal, the analog program/read circuit 202 programs the corresponding cell of the multilevel storage array. In the case of playing back of a stored analog signal, the analog program/read circuit 202 retrieves the analog voltage samples stored in the multilevel storage array 206 at a rate determined by the clock 204, and then filters the samples to generate a continuous-time analog signal.

In the case of recording an input digital signal, the digital-to-continuous time analog interface circuit 208 clocks in the input digital signal at a rate determined by the clock 210. The digital-to-continuous time analog interface circuit 208 then converts the received digital signal into a continuous-time analog signal. The continuous-time analog signal is then sent to the analog program/read circuit 202, where the continuous-time analog signal is sampled and stored in the multilevel storage array 206 at the rate of clock 204, as would an input analog signal.

In the case of producing an output digital signal, the analog program/read circuit 202 retrieves the corresponding analog voltage samples stored in the multilevel storage array 206 at a rate determined by the clock 204, and then filters the samples to generate a continuous-time analog signal. The continuous-time analog signal is then sent to the digital-to-continuous time analog interface circuit 208 which converts the continuous-time analog signal to the output digital signal at a rate determined by the clock 210.

An advantage of the analog/digital recording and playback system 200 of the invention is that the sample rate of the digital signal received and produced by the system 200 need not be the same as the sampling and retrieval rate of the analog signal. This makes the system 200 more versatile since it allows the system 200 to interface with different digital systems requiring different data rates. An additional advantage is that the input digital signal is stored in the multilevel storage array as an analog signal. Thus, the system 200 needs only an analog programming circuit. Moreover, the system 200 can produce both the continuous-time analog signal corresponding to the digital signal, as well as the corresponding digital signal itself, which again makes the system 200 more versatile.

FIG. 3 illustrates a block diagram of a more detailed embodiment of an analog/digital recording and playback system 300 in accordance with the invention. The system 300 comprises a microphone pre-amplifier 302 with automatic gain control (AGC) having inputs to receive the positive and negative terminals of a microphone (MIC+ and MIC−). The microphone inputs (MIC+ and MIC−) are also coupled to an input of a codec multiplexer 336. The pre-amplifier 302 further includes an AGC control input (AGCCAP) to control the gain of the pre-amplifier 302. The output of the pre-amplifier 302 is coupled to an input of an input source multiplexer 306. Also, the system 300 further includes another auxiliary pre-amplifier 310 having an auxiliary input (AUXIN) to receive an audio signal from another device. The output of the auxiliary pre-amplifier 310 is coupled to another input of the input source multiplexer 306 and to an input of a second summing amplifier 322. The input source multiplexer 306 has a control input (INS0) for selectively coupling one of its inputs to its output.

The analog/digital recording and playback system 300 further comprises a microphone bias supply 304 for supplying phantom power to an external microphone. The microphone bias supply 304 has a control input (AGPD) for enabling its voltage supply. The microphone bias supply 304 operates independently of the main power supply of the system 300 to reduce power leakage from the main power supply when an external microphone is used.

The output of input source multiplexer 306 is coupled to an input of a first summing amplifier 314, to an input of a volume-control multiplexer 338, and to another input of the codec multiplexer 336. The first summing amplifier 314 has a control input (SIM0-1) for selectively coupling either inputs to the output or the sum of the inputs. The output of the first summing amplifier 314 is coupled to the input of a filter multiplexer 316 and to another input of the volume-control multiplexer 338. The output of the filter multiplexer 316 is coupled to an input of a signal muting device 318. The signal muting device has a control input (AMTO) to selectively pass or attenuate its input to or from its output (i.e. to either attenuate the input signal or not). The output of the signal muting device 318 is coupled to a low pass filter 320. The low pass filter 320 has a control input (FLD0) to power down the filter when not used and control inputs (FLD0, FLD1) coupled to an internal clock to set the filter cut-off frequency. The output of the low pass filter 320 is coupled to another input of the second summing amplifier 322, to an input of a summing multiplexer 312, and to an input of an output multiplexer 342.

The output of the second summing amplifier 322 is coupled to another input of the output multiplexer 342, to another input of the volume-control multiplexer 338, to a sampled-and-hold circuit 328, and to another input of the codec multiplexer 336. The codec multiplexer 336 has a control input (CDI0-1) for selectively coupling one of its three inputs to its output. The output of the codec multiplexer 336 is coupled to a codec 348. The codec 348 includes a clock input for receiving an external clock signal (MCLK), an input for receiving a digital signal from a digital signal interface 352, and an output coupled to another input of the summing multiplexer 312, to another input of the volume control multiplexer 338, and to another input of the output multiplexer 342. The codec 342 further includes control inputs (ADPD, DAPD) to power down the Analog to Digital converter or the Digital to Analog converter when not used. The external clock input (MCLK), in addition to being coupled to an input of the codec 348, is also coupled to an input of an internal clock 324. A frequency divider 335 with an enable input (CDK2) may be provided to selectively divide the external clock by a factor of two (2).

The output of the volume-control multiplexer 338 is coupled to an input of a volume-control 340. The volume control has a first control signal (VLPD) to power down the volume control circuit when not used and another set of control inputs (VOL0-2) for controlling the level of the output signal. The output of the volume-control 340 is coupled to another input of the output multiplexer 340. The output multiplexer 340 includes a control input (OPS) for selectively coupling one of its inputs to its output. The output of the output multiplexer 342 is coupled to an input of a speaker amplifier 346 and to an input of an auxiliary amplifier 344. The amplifiers 344 and 346 have a control input (OPA) to selectively amplify and output the signal at the output of the output multiplexer 342.

The analog/digital record and playback system 300 further comprises a program/read control 332, an array I/O multiplexer 330, and 2×64 bit registers 334. The array I/O multiplexer 330 is coupled to a multilevel storage array 326 for selecting a particular storage cell to program or read. The program/read control 332 is coupled to the array I/O multiplexer 330 for programming or reading a selected storage cell. The read signal output of the program/read control 332 is coupled to another input of summing multiplexer 312 and another input of filter multiplexer 316. The summing multiplexer 312, in turn, has an output coupled to another input of the first summing amplifier 314. The sampled signal input to the program/read control 332 comes from the output of the sample-and-hold circuit 328.

The analog/digital recording and playback system 300 of the invention is very versatile. For instance, a microphone analog input signal can be routed to the output of the speaker amplifier 346 by way of the pre-amplifier 302, input source multiplexer 306, first summing amplifier 314, filter multiplexer 316, signal muting device 318, low pass filter 320, second summing amplifier 322, output multiplexer 342, and speaker amplifier 346. Or, the microphone analog input signal can routed to the output of the speaker amplifier 346 by way of the pre-amplifier 302, input source multiplexer 306, first summing amplifier 314, filter multiplexer 316, signal multing device 318, low pass filter 320, output multiplexer 342, and speaker amplifier 346. If volume control is desired, the microphone analog input signal can be routed to the output of the speaker amplifier 314 by way of the pre-amplifier 316, input source multiplexer 306, first summing amplifier 314, volume-control multiplexer 338, volume control 340, output multiplexer 342, and speaker amplifier 346.

The auxiliary input signal can be similarly routed to the output of the speaker amplifier 346, except that the auxiliary input signal is routed through the auxiliary amplifier 310 instead of the pre-amplifier 310. In addition, the auxiliary input signal can also be routed to the output of the speaker amplifier 346 by way of the auxiliary amplifier 310, second summing amplifier 322, output multiplexer 342, and speaker amplifier 346. The digital input signal at the digital signal interface 352 can be converted to continuous-time analog signal by the codec 348 and then routed to the output of the speaker amplifier 346 similar as the microphone input signal, except that the analog-converted digital signal routes through the summing multiplexer 312 instead of the input source multiplexer 306. In addition, the analog-converted digital signal can be routed to the output of the speaker amplifier 346 directly by way of the volume-control multiplexer 338, volume control 340, output multiplexer 342, and speaker amplifier 346. The microphone, auxiliary, and digital signals can also be similarly routed to the output of the auxiliary amplifier 344 by enabling the auxiliary amplifier 344.

The microphone and auxiliary input signals can also be converted to digital signals and routed to the digital signal interface 352. For instance, the microphone and auxiliary input signals can be routed to the codec 348 for conversion into digital format by way of the input source multiplexer 306 and the codec multiplexer 336. Or, the microphone and auxiliary input signals can be routed to the codec 348 for conversion into digital format by way of the input source multiplexer 306, first summing amplifier 314, filter multiplexer 316, signal muting device 318, low pass filter, 320, second summing amplifier 322 and the codec multiplexer 336. Additionally, the microphone input signal can be routed to the codec 348 directly by way of the codec multiplexer 336. Also, the auxiliary input signal can be routed to the codec 348 by way of the auxiliary amplifier 310, second summing amplifier 322, and codec multiplexer 336.

The microphone, auxiliary, and digital input signals can also be routed to the sample-and-hold circuit 328 for sampling and subsequent storage into the multilevel storage array. For instance, the microphone and auxiliary input signals can be routed to the sample-and-hold circuit 328 by way of the input source multiplexer 306, first summing amplifier 314, filter multiplexer 316, signal muting device 318, low pass filter 320, and second summing amplifier 322. In addition, the auxiliary input signal can be routed to the sample-and-hold circuit 328 by way of the auxiliary amplifier 310 and second summing amplifier 322. The analog-converted digital signal can be routed to the sample-and-hold circuit 328 by way of the summing multiplexer 312, first summing amplifier 314, filter multiplexer 316, signal muting device 318, low pass filter 320, and second summing amplifier 322.

The read analog signal from the multilevel storage array 326 can also be routed to the output of the speaker amplifier 346 (as well as the output of the auxiliary amplifier 344) and to the digital signal interface 352. If routed to the output of the speaker or auxiliary amplifier 346 or 344, the read analog signal is routed through the summing multiplexer 312, the first summing amplifier 314, the filter multiplexer 316, the signal muting device 318, the low pass filter 320, the second summing amplifier 322, and the output multiplexer 342. Alternatively, the read analog signal can be routed to the speaker or auxiliary amplifier 346 or 344 by way of the summing multiplexer 312, the first summing amplifier 314, the signal muting device 318, the low pass filter 320, and the output multiplexer 342. If volume control is desired, the read analog signal can be routed to the speaker or auxiliary amplifier 346 or 344 by way of the summing multiplexer 312, the first summing amplifier 314, the volume-control multiplexer 338, the volume control 340, and the output multiplexer 342. In addition, the read analog signal can be routed to the speaker or auxiliary amplifier 346 or 344 directly by way of the filter multiplexer 316, etc.

If the read analog signal is to be routed to the digital signal interface 352 and converted into digital format, the read analog signal is routed to the codec 348 by way of the output of the second summing amplifier 322 and the codec multiplexer 336. The codec 348 converts the read analog signal into digital format using the external sample rate clock input (WS). In addition, the codec 348 converts an input digital signal at the digital signal interface 352 into continuous-time analog signal using the external sample rate clock input (WS). An advantage of the analog/digital recording and playback system 300 of the invention is that the frequency of the external sample rate clock (WS) can be different than the frequency of the internal clock signal 324, thereby allowing the recording and playback of digital signals that have data rates different than the sampling rate of the analog signal.

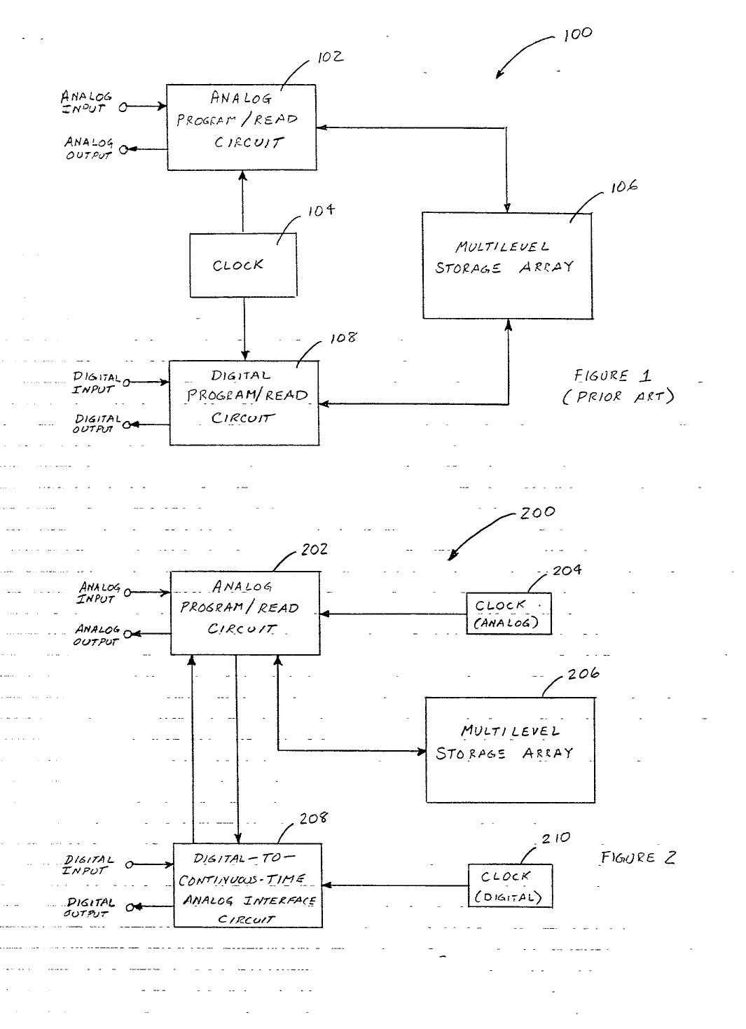

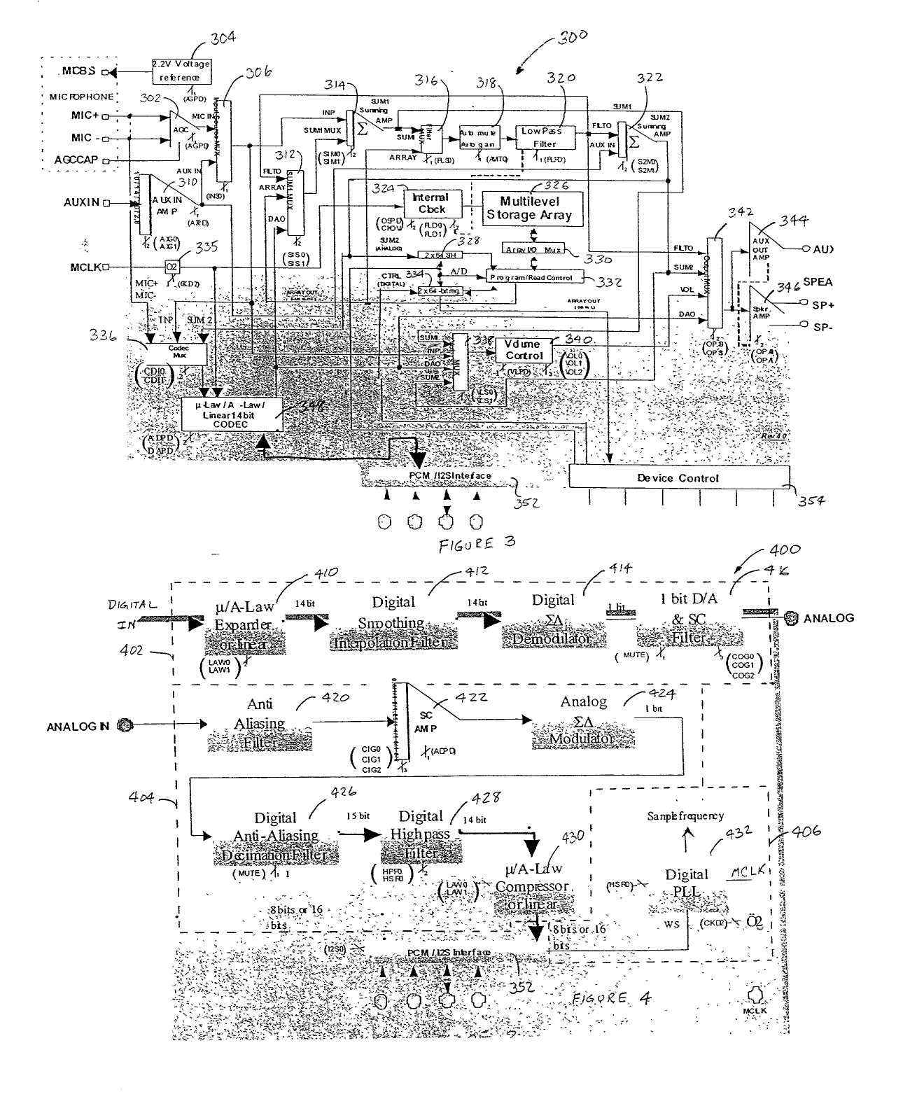

FIG. 4 illustrates a block diagram of an exemplary codec 400 in accordance with the invention. The codec 400 comprises a digital-to-continuous-time analog conversion section 402, a continuous-time analog-to-digital conversion section 404, and a clock section 406 for generating a clock signal used in both conversion processes.

The digital-to-continuous-time analog conversion section 402, in turn, comprises a μ/A-Law expander or linear device 410, a digital smoothing interpolation filter 412, a digital demodulator 414, and a 1-bit digital-to-analog converter and switch capacitor (SC) filter 416. The μ/A-Law expander or linear device 410 includes a control input (LAW0-1) to control whether the device 410 is to decompress data (μ/A-Law expander) if the received digital signal is compressed or not to decompress data (linear) if the received digital signal is uncompressed. The digital smoothing interpolation filter 412 performs the required interpolation. The digital demodulator 414 generates a pulse width modulated signal whose duty cycle is a function of the digital signal level at its input. The 1-bit digital-to-analog converter and SC filter 416 converts the pulse width modulated signal into a continuous-time analog signal for recording into the multilevel storage array and/or for producing the analog signal at one of its analog outputs.

The continuous-time analog-to-digital conversion section 404, in turn, comprises an anti-aliasing filter 420, a switch capacitor (SC) amplifier 422, an analog modulator 424, a digital anti-aliasing decimation filter 426, a digital high pass filter 428, and a μ/A-Law compressor or linear device 430. The anti-aliasing filter 420 filters the input analog signal to prevent aliasing with the internal or external clock of the analog/digital recording and playback system 300. The SC amplifier 422 generates samples of the averaged input analog signal. The SC amplifier 422 includes a control input (CIG-0-2) for setting the input gain. The analog modulator 424 receives the averaged analog samples and generates a pulse width modulated signal whose duty cycle is a function of the amplitude of the averaged analog samples.

The digital anti-aliasing decimination filter 426 generates a bit-representation (e.g. 15-bit representation) for each pulse of the pulse modulated signal. The digital anti-aliasing decimination filter 426 includes a control input (MUTE) to disable the filter 426. The digital high pass filter 428 deciminates the bit-representation signal from a higher sampling rate (e.g. 32 KHz) to a lower sampling rate (e.g. 8 KHz). The digital high pass filter 428 includes a control input (HPF0, HSR0) to enable or bypass the filter. The μ/A-Law compressor or linear device 430 compresses the outgoing digital data if desired or does not. The μ/A-Law compressor or linear device 430 includes a control input (LAW0-1) to selectively compress or not compress the outgoing digital data.

The clock signal section 406, in turn, comprises a digital phase lock loop (PLL) 432 having as an input the MCLK (or MCLK/2) clock signal and the digital data at the digital signal interface 352. The output of the digital (PLL) 432 serves as a clock for the digital demodulator 414 and the analog demodulator 424 in order for them to generate their respective pulse width modulated signals. The digital PLL 432 includes a control input (HSR0) for selection of a high sample rate mode and another control input (CKD2) which divides the master clock frequency by 2.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

It is claimed:

1. A method of recording a digital signal and an analog signal, comprising:
sampling said analog signal to form a first set of discrete analog samples;
storing said first set of discrete analog samples into a first set of respective cells of a memory array;
converting said digital signal into a continuous-time analog signal;
sampling said continuous-time analog signal to form a second set of discrete analog samples; and
storing said second set of discrete analog samples into a second set of respective cells of said memory array.

2. The method of claim 1, wherein converting said digital signal into a continuous-time analog signal comprises:
generating a pulse-width modulated signal whose duty cycle depends on respective sample levels of said digital signal; and
filtering said pulse-width modulated signal to form said continuous-time analog signal.

3. The method of claim 2, wherein converting said digital signal into a continuous-time analog signal further comprises reducing a sampling resolution of said digital signal prior to generating said pulse-width modulated signal.

4. The method of claim 1, further comprising decompressing said digital signal prior to converting said digital signal into a continuous-time analog signal.

5. A method of generating a digital signal and an analog signal, comprising:
retrieving a first set of discrete analog samples from a memory array;
filtering said first set of discrete analog samples to generate said analog signal;
retrieving a second set of discrete analog samples from said memory array;
filtering said second set of discrete analog samples to generate a continuous-time analog signal; and
converting said continuous-time analog signal into said digital signal.

6. The method of claim 5, wherein converting said continuous-time analog signal into said digital signal comprises:
generating discrete samples of said continuous-time analog signal; and
generating a pulse-width modulated signal whose duty cycle respectively depends on the amplitude of said discrete samples of said continuous-time analog signal; and
digitizing the pulse-width modulated signal.

7. The method of claim 6, wherein generating discrete samples of said continuous-time analog signal comprises generating said discrete samples that comprises an average voltage of said continuous-time analog signal between respective samples.

8. The method of claim 5, further comprising increasing a sampling resolution of said digital signal.

9. The method of claim 5, further comprising compressing said digital signal.

10. A method of recording a digital signal, comprising:
converting said digital signal into a continuous-time analog signal;
sampling said continuous-time analog signal to form a plurality of discrete analog samples; and
storing said plurality of discrete analog samples into respective cells of a memory array.

11. The method of claim 10, wherein converting said digital signal into a continuous-time analog signal comprises:
generating a pulse-width modulated signal whose duty cycle depends on respective sample levels of said digital signal; and
filtering said pulse-width modulated signal to form said continuous-time analog signal.

12. The method of claim 11, wherein converting said digital signal into a continuous-time analog signal further comprises reducing a sampling resolution of said digital signal prior to generating said pulse-width modulated signal.

13. The method of claim 11, further comprising decompressing said digital signal prior to converting said digital signal into a continuous-time analog signal.

14. A method of generating a digital signal, comprising:
retrieving a plurality of discrete analog samples from a memory array;
generating a continuous-time analog signal from said plurality of said discrete analog samples; and
converting said continuous-time analog signal into said digital signal.

15. The method of claim 14, wherein converting said continuous-time analog signal into said digital signal comprises:
generating discrete samples of said continuous-time analog signal; and
generating a pulse-width modulated signal whose duty cycle respectively depends on the amplitude of said discrete samples of said continuous-time analog signal.

16. The method of claim 15, wherein generating discrete samples of said continuous-time analog signal comprises generating said discrete samples that comprises an average voltage of said continuous-time analog signal between respective samples.

17. The method of claim 14, further comprising increasing a sampling resolution of said digital signal.

18. The method of claim 14, further comprising compressing said digital signal.

19. An analog/digital recording system, comprising:
a memory array;
a converter to convert a digital signal into a continuous-time analog signal; and
a programning device to generate a first set of discrete analog samples of said continuous-time analog signal and to store said first set of discrete analog samples into said memory array, and to generate a second set of discrete analog samples from an input analog signal and to store said second set of discrete analog samples into said memory array.

20. The analog/digital recording system of claim 19, wherein said converter comprises:
a digital demodulator to generate a pulse-width modulated signal whose duty cycle depends on respective sample levels of said digital signal; and
a filter to filter said pulse-width modulated signal to form said continuous-time analog signal.

21. The analog/digital recording system of claim 20, wherein said converter further comprises a digital smoothing interpolation filter to reduce a sampling resolution of said digital signal.

22. The analog/digital recording system of claim 19, further comprising an expander to decompress said digital signal prior to converting said digital signal into a continuous-time analog signal.

23. An analog/digital playback system, comprising:
a memory array to store first and second sets of analog samples;
a reading device to retrieve said first and second sets of analog samples and to generate first and second continuous-time analog signals respectively from said first and second sets of analog samples; and
a converter to convert said first continuous-time analog signal into a digital signal.

24. The analog/digital playback system of claim 24, wherein said converter comprises:
a switch capacitor amplifier to generate discrete samples of said continuous-time analog signal; and
an analog modulator to generate a pulse-width modulated signal whose duty cycle depends on the amplitude of respective discrete samples of said continuous-time analog signal.

25. The analog/digital playback system of claim 24, further comprising a digital anti-aliasing decimination filter to increase a sampling resolution of said digital signal.

26. The analog/digital playback system of claim 23, further comprising a compressor to compress said digital signal.

27. A digital recording system, comprising:
a memory array;
a converter to convert a digital signal into a continuous-time analog signal; and
a programming device to generate discrete analog samples of said continuous-time analog signal and to store said discrete analog samples into said memory array.

28. The analog/digital recording system of claim 27, wherein said converter comprises:
a digital demodulator to generate a pulse-width modulated signal whose duty cycle depends on respective sample levels of said digital signal; and
a filter to filter said pulse-width modulated signal to form said continuous-time analog signal.

29. The analog/digital recording system of claim 28, wherein said converter further comprises a digital smoothing interpolation filter to reduce a sampling resolution of said digital signal.

30. The analog/digital recording system of claim 27, further comprising an expander to decompress said digital signal prior to converting said digital signal into a continuous-time analog signal.

31. A digital playback system, comprising:
a memory array to store a plurality of analog samples;
a reading device to retrieve said plurality of analog samples and to generate a continuous-time analog signal from said plurality of analog samples; and
a converter to convert said continuous-time analog signal into a digital signal.

32. The analog/digital playback system of claim 31, wherein said converter comprises:
a switch capacitor amplifier to generate discrete samples of said continuous-time analog signal; and
an analog modulator to generate a pulse-width modulated signal whose duty cycle depends on the amplitude of respective discrete samples of said continuous-time analog signal.

33. The analog/digital playback system of claim 31, further comprising a digital anti-aliasing decimination filter to increase a sampling resolution of said digital signal.

34. The analog/digital playback system of claim 31, further comprising a compressor to compress said digital signal.
